(19) United States
(12) Patent Application Publication
(10) Pub. No.: US 2024/0428559 A1
(43) Pub. Date: Dec. 26, 2024

(54) ARTIFICIAL INTELLIGENCE HYGIENE CHECKLIST WITH AUTONOMOUS SCORING

(71) Applicant: INTERNATIONAL BUSINESS MACHINES CORPORATION, ARMONK, NY (US)

(72) Inventors: Martin G. Keen, Cary, NC (US); Jeremy R. Fox, Georgetown, TX (US); DIMITAR VESELINOV IVANOV, Veliko Tarnovo (BG); Paulo Roberto Pontin Tiziano, Sofia (BG)

(21) Appl. No.: 18/340,928

(22) Filed: Jun. 26, 2023

(51) Int. Cl. G06V 10/764; G06T 7/00; G06V 10/82; G06V 20/70

(52) U.S. Cl. CPC G06V 10/764; G06T 7/0002; G06V 10/82; G06V 20/70; G06T 2207/20084

(57) ABSTRACT

According to one embodiment, a method, computer system, and computer program product for classifying images is provided. The present invention may include receiving an image of a critical surface of a plurality of critical surfaces comprising a location; classifying the critical surface as clean or unclean based on a plurality of AI image filtering and labeling techniques; and uploading the image and the classification to a remotely accessible digital repository.

### BACKGROUND

The present invention relates, generally, to the field of computing, and more particularly to computer vision.

The field of computer vision may be concerned with equipping computers with the means to approximate the functionality of the human visual system. In practice, this entails utilizing computers to extract meaningful information from digital images, a task that, while easy for humans, is extraordinarily difficult for computers. Extracting meaningful information from an image may entail transforming the visual images into descriptions of the world that can interface with other cognitive processes to produce appropriate reactions. This image understanding can be seen as the disentangling of symbolic information from image data using models constructed with the aid of geometry, statistics, and learning theory. While many approaches to the task have been implemented over the past few decades, there remains a long way to go before digital image recognition begins to approach the speed and accuracy of a human being. However, advances in machine vision stand to yield significant and far-reaching benefits in many fields, including but not limited to that of hygiene assessment in public and private spaces such as restaurants, hospitals, and private homes.

### SUMMARY

According to one embodiment, a method, computer system, and computer program product for classifying images is provided. The present invention may include receiving an image of a critical surface of a plurality of critical surfaces comprising a location; classifying the critical surface as clean or unclean based on a plurality of AI image filtering and labeling techniques; and uploading the image and the classification to a remotely accessible digital repository.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment; and

FIG. 2 is an operational flowchart illustrating a hygiene assessment process according to at least one embodiment; and

FIG. 3 is an operational flowchart illustrating a hygiene assessment process according to at least one embodiment.

FIG. 4 is an illustration of a graphical user interface representing a hygiene report produced by a hygiene assessment process, according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to computer vision. The following described exemplary embodiments provide a system, method, and program product to, among other things, receive images of surfaces at a location, determine whether the surfaces are clean or unclean using machine learning techniques, and upload the images and the determination to a digital repository.

As previously described, the field of computer vision may be concerned with equipping computers with the means to approximate the functionality of the human visual system and may be applied to improve the process of measuring hygiene on surfaces within public and private homes and businesses. Assessing hygiene in a home or workplace is a massive and continuous process; businesses worldwide direct massive amounts of resources towards detergents, hygiene systems, personnel and processes to ensure hygienic and safe conditions for their customers. Lapses in hygiene standards can have negative and sometimes disastrous effects on individual's health and safety.

Currently, hygiene at a location may commonly be assessed by periodically conducting ATP surface tests for measuring the persistence and growth of live microorganisms through detection of adenosine triphosphate, or ATP. Surface samples may be collected by trained personnel with swabs. These samples may then be analyzed in labs with luminometer devices to determine a quantity of growing live microorganisms (bacteria) found on tested surfaces. However, ATP surface tests suffer from a number of drawbacks. For instance, the number of microorganisms on a surface is not necessarily a dependable metric for the cleanliness of such surface; for example, if a surface is treated with sanitizer, living organisms may be neutralized but the surface might still have visual pollution. Additionally, laboratory ATP tests are time consuming, and are extremely difficult to scale due to the logistics involving trained personnel, laboratories, and data reporting that are associated with the process. Portable ATP test devices do exist. However, such portable ATP test devices represent an expensive investment, and sampling can be biased by human behavior. Furthermore, ATP surface testing evaluates the hygiene on small sample surfaces and cannot provide accurate insights about the actual hygiene of restaurant kitchens, supermarkets, hotel rooms, hospital wards, food and beverage factories, et cetera.

As such, it may be advantageous to, among other things, implement a system that assesses the hygiene of a location by analyzing photographs, taken by an untrained user using a mobile device, of a number of critical surfaces at a location, using a machine learning model employing machine vision techniques; such system may assess the cleanliness of the surfaces and determine whether the surfaces are clean or not, and upload results to the cloud in real-time to provide remote real-time access to the cleanliness status of critical surfaces at a location. Therefore, the present embodiment has the capacity to improve the technical field of computer vision by leveraging computer vision and machine learning techniques to allow comprehensive hygiene assessment at a location in a scalable, secure, remotely accessible fashion covering all critical surfaces and without requiring trained personnel, in turn improving hygiene standards verification and compliance, improving hygiene of surfaces at a location, reducing incidents of bacterial contamination, and improving the health and safety of individuals at the location. Such a system may, for example, supplement ATP surface tests in assessing cleanliness at a location by providing an easy, convenient, scalable, and simple means of detecting surface dirt and grime between ATP tests.

According to at least one embodiment, the invention is a system and method for receiving images of one or more critical surfaces at a location, classifying the images as clean or unclean based on AI image filtering and labeling, and uploading the pictures and classifications to a remotely accessible digital repository.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The following described exemplary embodiments provide a system, method, and program product to receive images of surfaces at a location, determine whether the surfaces are clean or unclean using machine learning techniques, and upload the images and the determination to a digital repository.

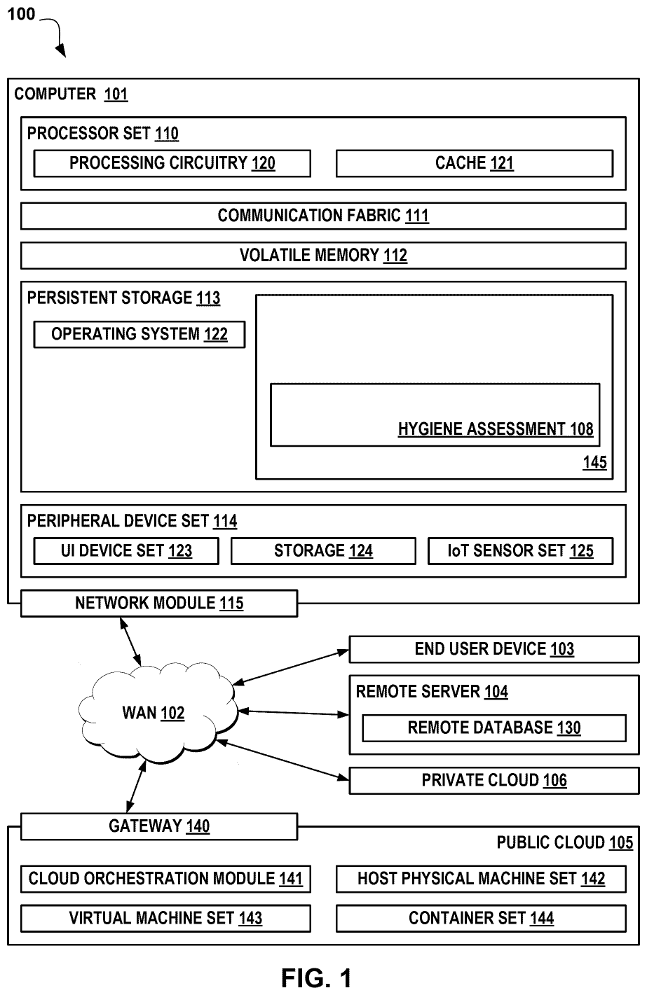

Referring now to FIG. 1, computing environment 100 contains an example of an environment for the execution of at least some of the computer code involved in performing the inventive methods, such as code block 145, which may comprise hygiene assessment program 108. In addition to code block 145, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code block 145, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code block 145 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in code block 145 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

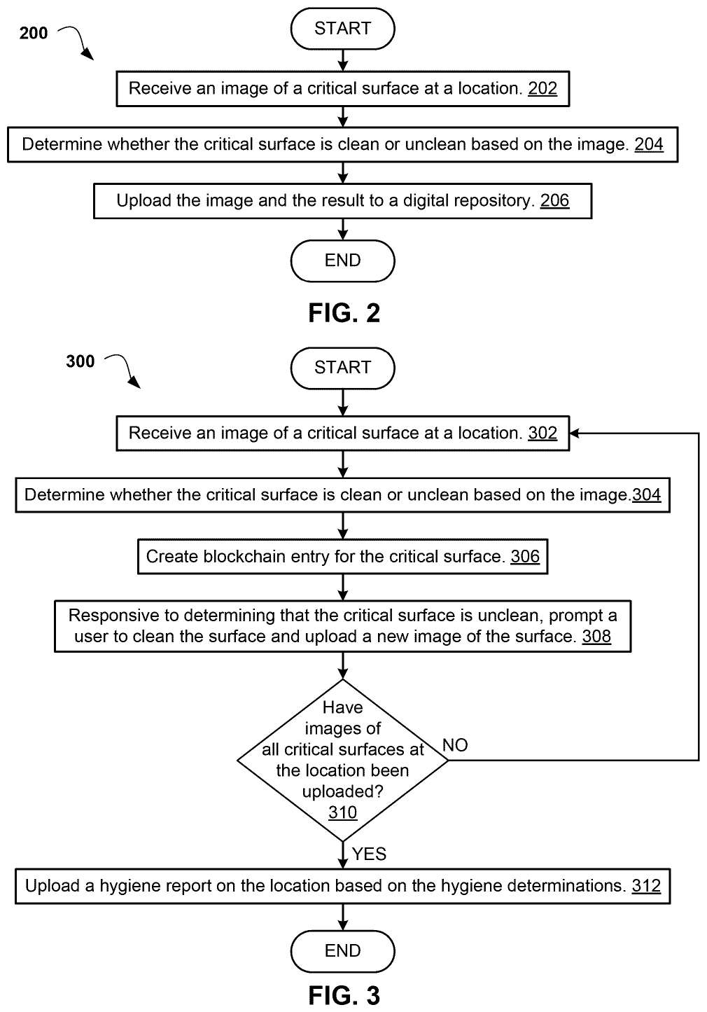

According to the present embodiment, the hygiene assessment program 108 may be a program enabled to receive images of surfaces at a location, determine whether the surfaces are clean or unclean using machine learning techniques, and upload the images and the determination to a digital repository. The hygiene assessment program 108 may, when executed, cause the computing environment 100 to carry out a hygiene assessment process 200. The hygiene assessment process 200 may be explained in further detail below with respect to FIG. 2. In embodiments of the invention, the hygiene assessment program 108 may be stored and/or run within or by any number or combination of devices including computer 101, end user device 103, remote server 104, private cloud 106, and/or public cloud 105, peripheral device set 114, and server 112 and/or on any other device connected to WAN 102. Furthermore, hygiene assessment program 108 may be distributed in its operation over any number or combination of the aforementioned devices.

Referring now to FIG. 2, an operational flowchart illustrating a hygiene assessment process 200 is depicted according to at least one embodiment. At 202, the hygiene assessment program 108 may receive an image of a critical surface at a location. The location may be any single contiguous physical area dedicated to a single purpose or owned/affiliated with a single entity. For example, a location may be a business, a private residential address, an industrial kitchen, a restaurant, et cetera. The location may range in size from a room or portion of a room to an entire building to a compound comprising several buildings. The location may comprise one or more surfaces; surfaces may be external layers of objects and environments that may come into contact with human individuals. Critical surfaces may be a subset of surfaces which are more important to keep clean, for a variety of reasons including an increased likelihood of coming into contact with individuals relative to other surfaces, an increased frequency of contacting food or other materials/substances/objects which in turn may come into contact with individuals, a likelihood of contacting substances/materials/objects with an unusually high risk of harming any individuals that might come into contact with them, et cetera. Critical surfaces may be pre-defined by a user, and may be limited to hard surfaces as tabletops, food preparation areas, exteriors of chemical storage canisters, et cetera, as hard surfaces may be more reliable to analyze using machine vision techniques. In embodiments, critical surfaces may include soft surfaces, such as seats and armrests of chairs, clothing, carpets, et cetera.

The hygiene assessment program 108 may receive an image of a critical surface at the location from a user, who may record the image using a mobile device associated with the user. In embodiments, the user may additionally specify which critical surface the image is depicting, or the hygiene assessment program 108 may utilize image processing techniques to identify the critical surface within the image. In embodiments, the user may enter the image into a graphical user interface comprising a hygiene dashboard, which may be a component of and/or an interface with hygiene assessment program 108, and which may be distributed in its operation and may comprise a client-side application or browser-based component accessible on a user's mobile device. The hygiene dashboard may be pre-populated with slots associated with each critical surface at the location, at which images associated with that critical location may be uploaded and which may graphically represent whether an image has or has not been uploaded for any given critical surface.

In embodiments, the hygiene assessment program 108 may operate or utilize wall- or table-mounted or mobile-platform-mounted cameras disposed in the location to take pictures of the surface. For example, the hygiene assessment program 108 may operate a static wall-mounted camera or a camera mounted on an autonomous vehicle to record an image of the critical surface. The hygiene assessment program 108 may record pictures of a given critical surface at regular intervals or in response to events; for example, the hygiene assessment program 108 may record a picture at the end of every workday, at the end of every shift, after every meal, every five hours, after a scheduled event, et cetera.

In embodiments, the hygiene assessment program 108 may prompt users of the hygiene dashboard to take and upload photographs of a critical surface at regular intervals or in response to events. For example, the hygiene assessment program 108 may prompt the user using by displaying a speech bubble and/or graphical element, and/or by playing a sound, on a mobile device associated with the user, such as a mobile phone or work-issued tablet. The hygiene assessment program 108 may prompt the user to upload pictures of a given critical surface, for example, at the end of every workday, at the end of every shift, after every meal, every five hours, after a scheduled event, et cetera. In embodiments, the hygiene assessment program 108 may only prompt individual users or a class of users associated with the critical surface. For example, the hygiene assessment program 108 may only prompt users classified as kitchen staff of a location comprising a restaurant to upload images of critical surfaces in the kitchen.

At 204, the hygiene assessment program 108 may determine whether the surface is clean or unclean based on the image. Here, the hygiene assessment program 108 may analyze the image to identify common objects in an image using an AI classification algorithm. The AI classification algorithm may utilize any technique to identify common objects within the image. For example, hygiene assessment program 108 may employ one or more convolutional neural networks (CNN), which are deep learning algorithms that can be used for image classification; through edge detection, a CNN can identify shapes in an image. The hygiene assessment program 108 may additionally or alternatively utilize region-based convolutional neural networks (R-CNN), which constitute an extension of the CNN which may be used for object detection in an image; R-CNN first identifies potential regions of interest, and then uses CNN to classify the objects in those regions. The hygiene assessment program 108 may use the You Only Look Once (YOLO) technique, which is a real-time object detection algorithm that can be used for both image classification and object detection.

The hygiene assessment program 108 may label the identified objects. The hygiene assessment program 108 may utilize a number of broad approaches to label the objects, such as abstraction, which may be a process of reducing a concept to its essentials by identifying the key features in an image that are relevant to the classification task; annotation, which may be a process of adding labels or tags to indicate what objects are present in the image; and classification, which may be a process of assigning a class label to an image (e.g., “oven” or “table”) to identify an overall subject of the image. These approaches may be embodied and/or applied using, for example, techniques such as CNN, R-CNN, and YOLO. The use of AI image filtering and labeling provides a specific and detailed analysis of surface hygiene, capable of identifying even minute pollutants or anomalies.

The hygiene assessment program 108 may then apply a series of anomaly detection methods to the images to identify color or shape anomalies in a critical surface which may indicate the presence of dirt, grime, stains, and other visual elements, which may indicate an unclean status of an object or surface in the image. The hygiene assessment program 108 may identify anomalies using, for example, convolutional neural network color filters, which may be used to extract color anomalies from surfaces by utilizing a series of layers (convolutional, pooling, and fully connected) to learn high-level features from images; with the high-level features established, the CNN applies color filters to extract color anomalies. In embodiments, the hygiene assessment program 108 may utilize 2D spatial transformation to identify anomalies. 2D spatial transformation may be used to learn the 2D spatial relationship between pixels in an image; the 2D spatial relationships can be used to identify patterns in the image that may indicate pollution or dirt. For example, a series of dark pixels in a certain pattern may indicate the presence of a stain. The hygiene assessment program 108 may detect anomalies utilizing Anomaly Detection in Time-Series Images, which may be a method for detecting anomalies in a series of images over time. This method may be used to identify when a critical surface becomes polluted or dirty, the rate at which the surface becomes polluted, as well as when a surface is cleaned and the rate at which the surface becomes clean. The hygiene assessment program 108 may employ 3D Spatial Transformation, whereby the 3D spatial relationships between pixels in the image may be quantified, and which may be utilized where mobile devices capture the same image across multiple cameras, for example using the three camera lens commonly integrated into modern mobile devices; because each picture is taken with a different focal length and from a slightly different position, the hygiene assessment program 108 may calculate the depth of the image, which in turn enables the hygiene assessment program 108 to create a three-dimensional spatial transformation whereby multiple planes of an image may be analyzed. This method may be used in conjunction with other methods to provide more accurate results. The application of multiple anomaly detection methods may enable hygiene assessment program 108 to discern patterns, color anomalies, and changes over time, offering a more comprehensive and accurate assessment of hygiene status.

The hygiene assessment program 108 may identify whether the surface is clean or unclean based on the image analysis. The hygiene assessment program 108 may provide the analyzed, labeled images and detected anomalies to a machine learning model as input, and may receive as output a hygiene result which may be “clean” or “unclean.” The machine learning model may further output a confidence score, where the confidence score indicates a level of certainty in the correctness of the result. The confidence score may be a number between 1 and 0, where the higher the number the greater the uncertainty. In embodiments, the number may be between 1 and 0, where the higher the number, the greater the certainty. In embodiments, the confidence score may be made available to be displayed to users, for example by integrating the confidence score into the hygiene status and/or hygiene report in a digital repository, such that users may gain an understanding of how likely the determination of cleanliness or uncleanliness is to be correct. In embodiments, the confidence score, along with the cleanliness determination and associated image data, may be fed to the machine learning model in order to improve future results.

At 206, the hygiene assessment program 108 may upload the image and the result to a digital repository. The digital repository may be a data repository connected to the network which users may remotely access and view the hygiene result and/or associated data, such as the images, the labels, objects and classifications extracted from the images, the confidence score associated with a hygiene result for a critical surface, the time at which the images were uploaded, et cetera. The hygiene dashboard may be at least partially located on, or receive information from, the digital repository, and may graphically reflect the hygiene status of each image of the critical surfaces, for example by displaying a green border around an image of a critical surface which hygiene assessment program 108 determined to be clean, a red border around an image of a critical surface which hygiene assessment program 108 determined to be unclean, and/or a yellow border around an image of a critical surface which has not had an image uploaded for a period of time exceeding a threshold; the threshold may enumerate a time period past a deadline for uploading an image within which an uploaded image may still be considered timely, but at or beyond which uploading the image may be considered late, such that the delay may compromise hygiene and safety standards.

In embodiments, the digital repository may comprise a blockchain. A blockchain is a distributed and immutable ledger that records transactions or other data across multiple computers or nodes. Transactions within the ledger, such as uploads of images, image data, hygiene assessments, et cetera are recorded only once, and cannot be changed once recorded. If a transaction includes an error, a new transaction must be added to reverse the error, and both transactions may be then visible. Each transaction is stored as a block of data, with a string of transactions forming a chain that confirms the exact time and sequence of transactions, strengthens the verification of the component blocks, and renders the blockchain tamper evident. In embodiments, after the images have been classified, labeled, and/or analyzed for anomalies, the images may be stored on the blockchain. The image data extracted at the classifying, labeling, and/or anomaly detection steps may be uploaded to the blockchain platform as it is extracted, separately of the images. The blockchain may be public, such that anyone may access the blockchain. The blockchain may be owned and/or operated by one or more entities associated with the location; for example, where the location is a business, the blockchain may be owned and operated by the owner, franchisee, manager, et cetera of the business, and may be accessed by employees and/or officers of the business. Where the location is a private residence, the blockchain may be owned and/or operated by the owner. The use of blockchain technology ensures the integrity and security of the data collected, making data collection more reliable and trustworthy.

Referring now to FIG. 3, an operational flowchart illustrating a hygiene assessment process 300 is depicted according to at least one embodiment. At 302, the hygiene assessment program 108 may receive an image of a critical surface at a location. The hygiene assessment program 108 may receive an image of a critical surface at the location from a user, who may record the image using a mobile device associated with the user. In embodiments, the user may additionally specify which critical surface the image is depicting, or the hygiene assessment program 108 may utilize image processing techniques to identify the critical surface within the image. In embodiments, the user may enter the image into a graphical user interface comprising a hygiene dashboard, which may be a component of and/or an interface with hygiene assessment program 108, and which may be distributed in its operation and may comprise a client-side application or browser-based component accessible on a user's mobile device. The hygiene dashboard may be pre-populated with slots associated with each critical surface at the location, at which images associated with that critical location may be uploaded and which may graphically represent whether an image has or has not been uploaded for any given critical surface. In embodiments, the hygiene assessment program 108 may operate or utilize wall- or table-mounted or mobile-platform-mounted cameras disposed in the location to take pictures of the surface. The hygiene assessment program 108 may record pictures of a given critical surface or prompt a user to upload images of the critical surface, at regular intervals or in response to events. In embodiments, the hygiene assessment program 108 may only prompt individual users or a class of users associated with the critical surface.

At 304, the hygiene assessment program 108 may determine whether the surface is clean or unclean based on the image. Here, the hygiene assessment program 108 may analyze the image to identify common objects in an image using an AI classification algorithm. The AI classification algorithm may utilize any technique to identify common objects within the image. For example, hygiene assessment program 108 may employ one or more convolutional neural networks (CNN), which are deep learning algorithms that can be used for image classification; through edge detection, a CNN can identify shapes in an image. The hygiene assessment program 108 may additionally or alternatively utilize region-based convolutional neural networks (R-CNN), which constitute an extension of the CNN which may be used for object detection in an image; R-CNN first identifies potential regions of interest, and then uses CNN to classify the objects in those regions. The hygiene assessment program 108 may use the You Only Look Once (YOLO) technique, which is a real-time object detection algorithm that can be used for both image classification and object detection.

The hygiene assessment program 108 may label the identified objects. The hygiene assessment program 108 may utilize a number of broad approaches to label the objects, such as abstraction, which may be a process of reducing a concept to its essentials by identifying the key features in an image that are relevant to the classification task; annotation, which may be a process of adding labels or tags to indicate what objects are present in the image; and classification, which may be a process of assigning a class label to an image (e.g., “oven” or “table”) to identify an overall subject of the image.

The hygiene assessment program 108 may then apply a series of anomaly detection methods to the images to identify color or shape anomalies in a critical surface which may indicate the presence of dirt, grime, stains, and other visual elements, which may indicate an unclean status of an object or surface in the image. The hygiene assessment program 108 may identify anomalies using, for example, convolutional neural network color filters, which may be used to extract color anomalies from surfaces by utilizing a series of layers (convolutional, pooling, and fully connected) to learn high-level features from images; with the high-level features established, the CNN applies color filters to extract color anomalies. In embodiments, the hygiene assessment program 108 may utilize 2D spatial transformation to identify anomalies. 2D spatial transformation may be used to learn the 2D spatial relationship between pixels in an image; the 2D spatial relationships can be used to identify patterns in the image that may indicate pollution or dirt. The hygiene assessment program 108 may detect anomalies utilizing Anomaly Detection in Time-Series Images, which may be a method for detecting anomalies in a series of images over time. This method may be used to identify when a critical surface becomes polluted or dirty, the rate at which the surface becomes polluted, as well as when a surface is cleaned and the rate at which the surface becomes clean. In embodiments, the hygiene assessment program 108 may normalize a hygiene result to account for stains or discolorations that persist despite acceptable levels of cleaning, such that persistent stains or discolorations may have a decreasing effect on the hygiene results the longer they are present, and/or may no longer affect the hygiene result if the discoloration is present for a threshold period of time. This prevents situations where an indelible mark on a critical surface causes hygiene assessment program 108 to classify the critical surface as unclean even if the surface was otherwise thoroughly cleaned. The hygiene assessment program 108 may employ 3D Spatial Transformation, whereby the 3D spatial relationships between pixels in the image may be quantified, and which may be utilized where mobile devices capture the same image across multiple cameras. This method may be used in conjunction with other methods to provide more accurate results.

The hygiene assessment program 108 may identify whether the surface is clean or unclean based on the image analysis. The hygiene assessment program 108 may provide the analyzed, labeled images and detected anomalies to a machine learning model as input, and may receive as output a hygiene result which may be “clean” or “unclean.” The machine learning model may further output a confidence score, where the confidence score indicates a level of certainty in the correctness of the result. The confidence score may be a number between 1 and 0, where the higher the number the greater the uncertainty.

At 306, the hygiene assessment program 108 may create a blockchain entry for the critical surface. Uploads of images, image data, hygiene assessments, and other such transactions may be recorded as a block of data in the blockchain. The transactions may be encrypted. The image data extracted at the classifying, labeling, and/or anomaly detection steps may be uploaded to the blockchain platform as it is extracted, separately of the images, for example resulting in hygiene assessment program 108 recording the upload of the image itself and the upload of output from the classifying, labeling, and anomaly detection steps in separate blocks.

At 308, the hygiene assessment program 108 may, responsive to determining that the critical surface is unclean, prompt a user to clean the surface and upload a new image of the surface. As the hygiene result may be performed in real time or near real time responsive to receiving the uploaded image, the hygiene assessment program 108 may provide a user with real time or near real time feedback regarding the clean or unclean status of a surface regarding which a user has just uploaded an image. If the hygiene assessment program 108 determines a critical surface to be unclean based on the image uploaded by the user, the hygiene assessment program 108 may prompt the user to clean the critical surface and upload a new image of the critical surface. The hygiene assessment program 108 may prompt the user using by displaying a speech bubble and/or graphical element, and/or by playing a sound, on a mobile device associated with the user, such as a mobile phone or an employer-issued tablet.

At 310, the hygiene assessment program 108 determines whether images of all critical surfaces at the location have been uploaded, for example by comparing a list of critical surfaces associated with recently uploaded images against a list of all critical surfaces associated with a location. If there are any critical surfaces associated with a location that are not present on the list of critical surfaces with recently uploaded images, the hygiene assessment program 108 may determine that images of all critical surfaces at the location have not been uploaded. According to one implementation, if the hygiene assessment program 108 determines that images of all critical surfaces have been uploaded (step 310, “YES” branch), the hygiene assessment program 108 may continue to step 312 to upload a hygiene report on the location based on the blockchain entries. If the hygiene assessment program 108 determines that images of all critical surfaces at the location have not been uploaded (step 310, “NO” branch), the hygiene assessment program 108 may continue to step 302 to receive an image of a critical surface at a location.

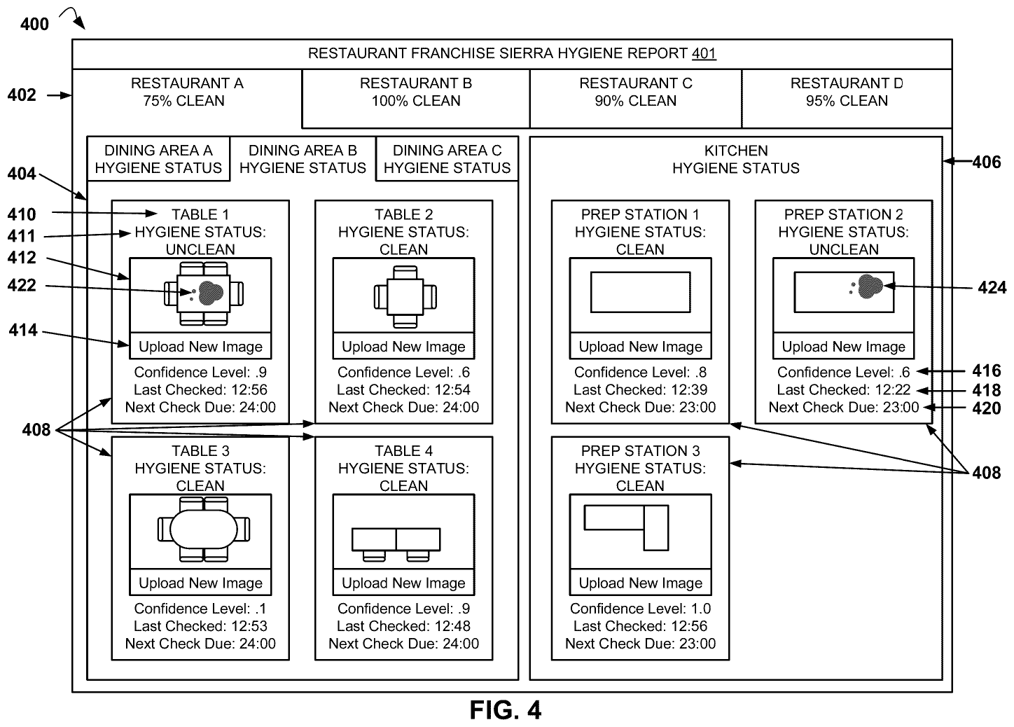

At 312, the hygiene assessment program 108 may upload a hygiene report on the location based on the hygiene determinations. Once images of all of the critical surfaces associated with a location have been uploaded and analyzed, the hygiene assessment program 108 may compile a hygiene report based on the hygiene determinations and confidences determined with respect to the critical surfaces. The hygiene report may be uploaded to the blockchain and may be accessible in the hygiene dashboard. The hygiene report may display the hygiene results of every critical surface and may display the hygiene results next to an uploaded image of their corresponding critical surface, which may be the most recently uploaded image. The hygiene report may further display the confidence score, the percentage of clean results and/or the percentage of unclean results, whether one or more applicable hygiene standards was passed or failed, statistics regarding the cleanliness of individual critical surfaces derived from an analysis of past data and uploaded images, et cetera. The hygiene report may be discussed in greater detail with respect to FIG. 4.

Referring now to FIG. 4, an exemplary implementation of a graphical user interface comprising a hygiene report 400 produced by a hygiene assessment process 300 is depicted according to at least one embodiment. Here, a hygiene report 400 comprises a graphical representation of cleanliness for a restaurant franchise Sierra, which consists of four locations, Restaurant A, Restaurant B, Restaurant C, and Restaurant D. Each location comprises a number of surfaces, separated into two groups, or classes, based on their function and location: dining areas and kitchens. The hygiene report 400 may, for example, be located on a private cloud 106 or remote server 104, and may be remotely accessible by one or more users and/or classes of users and may be displayed to a user using a display device comprising a computer 101, such as the screen of a tablet or mobile phone.

Hygiene report 400 comprises a window 401 which is labeled with the name of the franchise, Restaurant Franchise Sierra. Window 401 comprises a sub-window 402, which comprises a tab for each restaurant comprising the Restaurant Franchise Sierra, Restaurant A, Restaurant B, Restaurant C, and Restaurant D. Each tab provides an overall cleanliness of the associated location, based on the number of critical surfaces comprising that location which are currently considered clean or unclean. Upon user selection of a tab, the hygiene assessment program 108 displays a number of sub-windows equivalents to the number of groups of critical surfaces comprising the location. Here, the hygiene assessment program 108 displays a dining area sub-window 404, and a kitchen sub-window 406. In embodiments, a location may comprise multiple sub-locations of distinct purpose, each comprising critical surfaces; the hygiene assessment program 108 may display a sub-window for each sub-location, displaying all critical surfaces within that sub-location. Here, each restaurant comprising Restaurant Franchise Sierra comprises one kitchen and multiple dining areas; because there are multiple dining areas, hygiene assessment program 108 displays a number of tabs each corresponding to a different dining area within the dining area sub-window 404; these tabs may be selected to switch the display to show all critical surfaces present within the dining area corresponding to the selected tab. In embodiments, as with the tabs of window 402, the tabs and/or sub-windows associated with a sub-location may further comprise a percentage cleanliness associated with that sub-location, based on the number of “clean” determinations of critical surfaces comprising that sub-location.

The sub-windows may comprise a critical surface window 408 for each critical surface comprising the sub-location; the critical surface window 408 may comprise a title 410 indicating the critical surface associated with the critical surface window 408, as well as a hygiene status 411, which may be a binary determination of the hygienic state of the associated critical surface, such as “clean” or “unclean.” The critical surface window 408 may comprise an image 412 of the associated critical surface. The critical surface window 408 here comprises a button 414 which may be clicked, selected, or otherwise interacted with by a user to open an image uploading tool through which a new image of the critical surface may be remotely uploaded, for example from a user's mobile device. The critical surface window 408 may display a confidence level 416, which indicates a likelihood that the hygiene status 411 is correct and accurate. The critical surface window 408 may display a last upload time 418, which indicates the last time an image 412 of the associated critical surface was uploaded to the hygiene report 400, as well as a next upload time 420 which indicates the time when a new image 412 of the associated critical surface should be uploaded.

Here, hygiene assessment program 108 has detected a stain 422 in an image 412 corresponding to Table 1; as a result, the hygiene status 411 of Table 1 is unclean. Likewise, hygiene assessment program 108 has detected a spill 424 in the image 412 of Prep Station 2 and has likewise determined the hygiene status 411 of Prep Station 2 to be unclean. The hygiene assessment program 108 may prompt one or more users to clean Table 1 and Prep Station 2 and upload new images 412 of the respective critical surfaces, and may change the respective critical surface windows 408 to red until the hygiene status 411 is once again identified to be clean, in which case hygiene assessment program 108 may change the critical surface windows 408 back to a green color. In embodiments, if the next upload time 420 for a critical surface passes without a new image having been uploaded, the hygiene assessment program 108 may prompt a user to upload a new image 412, and/or may change the color of the associated critical surface window 408 to yellow. If a threshold duration of time passes after the prompt without an upload, the hygiene assessment program 108 may change the status 411 of the critical surface to “unclean.”

It may be appreciated that FIGS. 2-4 provide only illustrations of individual implementations and do not imply any limitations with regard to how different embodiments may be implemented. Many modifications to the depicted environments may be made based on design and implementation requirements. For example, in FIG. 4, the hygiene report 400 may, rather than comprising a separate sub-window for each group, namely dining area sub-window 404 and the kitchen sub-window 406, instead comprise only one sub-window with a tab for each sub-location. Alternatively, hygiene report 400 may comprise a separate sub-window for each sub-location or may comprise a separate sub-window for each group of critical locations, instead of comprising tabs. In embodiments, the critical location windows 408 may display any number or combination of data pertinent to the sub-location, and may display different data to different types or classes of users; for example, the hygiene assessment program 108 may display confidence levels 416 within critical location windows 408 only to users that are identified as administrators or managers, may only show sub-windows of sub-locations to users that work in and/or are responsible for the cleanliness of critical surfaces within that sub-location, and/or may only display tabs for locations where a given user is not located or employed to users who are identified as managers.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for classifying images, the method comprising:
receiving an image of a critical surface of a plurality of critical surfaces comprising a location;
classifying the critical surface as clean or unclean based on a plurality of AI image filtering and labeling techniques; and
uploading the image and the classification to a remotely accessible digital repository.

2. The method of claim 1, wherein the image is received from a static or mobile vehicle mounted camera observing the critical surface.

3. The method of claim 1, wherein the AI filtering and labeling techniques are selected from a list consisting of: convolutional neural networks, region-based convolutional neural networks, and you only look once algorithms.

4. The method of claim 1, wherein the classifying is further based on identifying one or more anomalies on the critical surface using one or more anomaly detection methods.

5. The method of claim 4, wherein the anomaly detection methods comprise Anomaly Detection in Time Series Images, and wherein the method further comprises: normalizing the classifying to account for a duration that a detected anomaly has persisted on the critical surface.

6. The method of claim 1, further comprising: responsive to determining that at least one image has been uploaded for each of the plurality of critical surfaces, uploading a hygeine report to the digital repository.

7. The method of claim 1, wherein the digital repository comprises a blockchain.

8. A computer system for classifying images, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
receiving an image of a critical surface of a plurality of critical surfaces comprising a location;
classifying the critical surface as clean or unclean based on a plurality of AI image filtering and labeling techniques; and
uploading the image and the classification to a remotely accessible digital repository.

9. The computer system of claim 8, wherein the image is received from a static or mobile vehicle mounted camera observing the critical surface.

10. The computer system of claim 8, wherein the AI filtering and labeling techniques are selected from a list consisting of: convolutional neural networks, region-based convolutional neural networks, and you only look once algorithms.

11. The computer system of claim 8, wherein the classifying is further based on identifying one or more anomalies on the critical surface using one or more anomaly detection methods.

12. The computer system of claim 11, wherein the anomaly detection methods comprise Anomaly Detection in Time Series Images, and wherein the method further comprises: normalizing the classifying to account for a duration that a detected anomaly has persisted on the critical surface.

13. The computer system of claim 8, further comprising: responsive to determining that at least one image has been uploaded for each of the plurality of critical surfaces, uploading a hygeine report to the digital repository.

14. The computer system of claim 8, wherein the digital repository comprises a blockchain.

15. A computer program product for classifying images, the computer program product comprising:
one or more computer-readable tangible storage medium and program instructions stored on at least one of the one or more tangible storage medium, the program instructions executable by a processor to cause the processor to perform a method comprising:
receiving an image of a critical surface of a plurality of critical surfaces comprising a location;
classifying the critical surface as clean or unclean based on a plurality of AI image filtering and labeling techniques; and
uploading the image and the classification to a remotely accessible digital repository.

16. The computer program product of claim 15, wherein the image is received from a static or mobile vehicle mounted camera observing the critical surface.

17. The computer program product of claim 15, wherein the AI filtering and labeling techniques are selected from a list consisting of: convolutional neural networks, region-based convolutional neural networks, and you only look once algorithms.

18. The computer program product of claim 15, wherein the classifying is further based on identifying one or more anomalies on the critical surface using one or more anomaly detection methods.

19. The computer program product of claim 18, wherein the anomaly detection methods comprise Anomaly Detection in Time Series Images, and wherein the method further comprises: normalizing the classifying to account for a duration that a detected anomaly has persisted on the critical surface.

20. The computer program product of claim 15, further comprising: responsive to determining that at least one image has been uploaded for each of the plurality of critical surfaces, uploading a hygiene report to the digital repository.
